(19) United States
(12) Patent Application Publication
(10) Pub. No.: US 2024/0249658 A1
(43) Pub. Date: Jul. 25, 2024

(54) METHOD FOR DRIVING DISPLAY PANEL, AND DISPLAY DEVICE

(71) Applicants: Hefei BOE Display Technology Co., Ltd., Hefei, Anhui (CN); BOE Technology Group Co., Ltd., Beijing (CN)

(72) Inventors: Liugang ZHOU, Beijing (CN); Jinshui CHEN, Beijing (CN); Jianwei SUN, Beijing (CN); Zhihua SUN, Beijing (CN); Wu WANG, Beijing (CN); Jun WANG, Beijing (CN); Jiao LIU, Beijing (CN); Jie DENG, Beijing (CN); Jiantao LIU, Beijing (CN)

(21) Appl. No.: 18/016,284

(22) PCT Filed: Feb. 24, 2022
(86) PCT No.: PCT/CN2022/077765

§ 371 Date: Jan. 13, 2023

(51) Int. Cl. G09G 3/20; G09G 3/3291; G09G 3/36

(52) U.S. Cl. CPC G09G 3/2074; G09G 3/2003; G09G 3/3291; G09G 3/3607; G09G 3/3688; G09G 2300/0452; G09G 2310/08; G09G 2320/0233; G09G 2320/0242; G09G 2320/0285

(57) ABSTRACT

Provided are a method for driving a display panel, and a display device. The method includes: obtaining a gray scale value of each sub-pixels in a current row and a gray scale value of each sub-pixels in a previous row; determining a target gray scale value of each sub-pixel in the current row according to the gray scale value of each sub-pixel in the current row, the gray scale value of each sub-pixel in the previous row, and a target compensation value in a predetermined target compensation lookup table; and inputting a data voltage into a data line in the display panel according to the target gray scale value of each sub-pixel in the current row, to charge with a corresponding data voltage to each sub-pixel in the current row.

### CROSS REFERENCE TO RELATED APPLICATIONS

The present disclosure is a National Stage of International Application No. PCT/CN2022/077765, filed Feb. 24, 2022.

### FIELD

The present disclosure relates to the technical field of display, and in particular to a method for driving a display panel, and a display device.

### BACKGROUND

Generally, a display such as a liquid crystal display, LCD, or an organic light-emitting diode, OLED, display includes a plurality of pixel units. Each pixel unit can be composed of a red sub-pixel, a green sub-pixel, and a blue sub-pixel. With the brightness of each sub-pixel controllable, a color image can be displayed through mixed colors to be displayed.

### SUMMARY

In a first aspect, a method for driving a display panel provided by an embodiment of the present disclosure includes:
obtaining a gray scale value of each sub-pixel in a current row and a gray scale value of each sub-pixel in a previous row;
determining a target gray scale value of each sub-pixel in the current row according to the gray scale value of each sub-pixel in the current row, the gray scale value of each sub-pixel in the previous row, and a target compensation value in a predetermined target compensation lookup table; where the target compensation value is obtained according to a set gray scale picture and a set overload picture displayed on the display panel; and
inputting a data voltage into a data line in the display panel according to the target gray scale value of each sub-pixel in the current row, to charge with a corresponding data voltage to each sub-pixel in the current row.

In some embodiments, the target compensation lookup table includes a plurality of different first gray scale values, a plurality of different second gray scale values, and target compensation values corresponding to any one of the first gray scale values, and target compensation values corresponding to any one of the second gray scale values; and
determining the target compensation value in the target compensation lookup table includes:
obtaining an original compensation lookup table; where the original compensation lookup table includes the plurality of different first gray scale values, the plurality of different second gray scale values, and original compensation values corresponding to any one of the first gray scale values, and original compensation values corresponding to any one of the second gray scale values; and
determining the target compensation value in the target compensation lookup table according to a predetermined compensation gain and the original compensation values in the original compensation lookup table; where the compensation gain is obtained according to the set gray scale picture and the set overload picture displayed on the display panel.

In some embodiments, a display area of the display panel has a plurality of predetermined compensation areas, one compensation area corresponding to one target compensation lookup table and one compensation gain; and
determining a target compensation value in the target compensation lookup table for each compensation area includes:
obtaining an original compensation lookup table corresponding to the compensation area; and
determining the target compensation value in the target compensation lookup table corresponding to the compensation area according to a predetermined compensation gain corresponding to the compensation area and an original compensation value in the original compensation lookup table.

In some embodiments, determining the compensation gain corresponding to each compensation area includes:
obtaining an overload detection image when the display panel displays the set overload picture, and a gray scale detection image when the display panel displays the set gray scale picture;
determining an overload detection compensation value corresponding to each compensation area according to brightness of the overload detection image in each compensation area, and determining a gray scale detection compensation value corresponding to each compensation area according to brightness of the gray scale detection image in each compensation area; and
determining the compensation gain corresponding to each compensation area according to the gray scale detection compensation value corresponding to each compensation area and the overload detection compensation value corresponding to each compensation area.

In some embodiments, the compensation gain corresponding to each compensation area is determined according to the gray scale detection compensation value corresponding to each compensation area and the overload detection compensation value corresponding to each compensation area through a formula as follows:

$$Gi1\_a = 1 + ( Dc1\_a - Dn1\_a ) / Ds ;$$

where Gi1_a represents the compensation gain corresponding to an ath compensation area, Dc1_a represents the overload detection compensation value corresponding to the ath compensation area, Dn1_a represents the gray scale detection compensation value corresponding to the ath compensation area, Ds represents a reference value, and a is an integer greater than 0.

In some embodiments, the reference value is one of the gray scale detection compensation values.

In some embodiments, the target compensation value in the target compensation lookup table corresponding to the compensation area is determined through a formula as follows:

$$LMD1\_a = LYD1\_a * Gi1\_a ;$$

where LMD1_a represents the target compensation value in the target compensation lookup table corresponding to the ath compensation area, and LYD1_a represents the original compensation value in the original compensation lookup table corresponding to the ath compensation area.

In some embodiments, the compensation gain corresponding to each compensation area is determined according to the gray scale detection compensation value corresponding to each compensation area and the overload detection compensation value corresponding to each compensation area through a formula as follows:

$$Gi2\_a = Dc2\_a - Dn2\_a ;$$

where Gi2_a represents the compensation gain corresponding to an ath compensation area, Dc2_a represents the overload detection compensation value corresponding to the ath compensation area, Dn2_a represents the gray scale detection compensation value corresponding to the ath compensation area, and a is an integer greater than 0.

In some embodiments, the target compensation value in the target compensation lookup table corresponding to the compensation area is determined through a formula as follows:

$$LMD2\_a = LYD2\_a + Gi2\_a ;$$

where LMD2_a represents the target compensation value in the target compensation lookup table corresponding to the ath compensation area, LYD2_a represents the original compensation value in the original compensation lookup table corresponding to the ath compensation area, and Gi2_a represents the compensation gain corresponding to the ath compensation area.

In some embodiments, the determining a target gray scale value corresponding to each sub-pixel in the current row according to the gray scale value of each sub-pixel in the current row, the gray scale value of each sub-pixel in the previous row, and a target compensation value in a predetermined target compensation lookup table includes:
determining a target compensation value corresponding to a gray scale value of a sub-pixel in the current row and a gray scale value of a sub-pixel in the previous row both connected to the same data line from the target compensation lookup table; and
determining a target gray scale value of the sub-pixel in the current row connected to the same data line by adding an original gray scale value of the sub-pixel in the current row connected to the same data line with the target compensation value.

In some embodiments, the gray scale value of each sub-pixel in the current row is an original gray scale value of each sub-pixel in the current row, and the gray scale value of each sub-pixel in the previous row is an original gray scale value of each sub-pixel in the previous row.

In some embodiments, the gray scale value of each sub-pixel in the current row is an original gray scale value of each sub-pixel in the current row, and the gray scale value of each sub-pixel in the previous row is a target gray scale value of each sub-pixel in the previous row.

In a second aspect, a display device provided by an embodiment of the present disclosure includes:
a display panel; and
a time controller configured for obtaining a gray scale value of each sub-pixel in a current row and a gray scale value of each sub-pixel in a previous row; determining a target gray scale value of each sub-pixel in the current row according to the gray scale value of each sub-pixel in the current row, the gray scale value of each sub-pixel in the previous row, and a target compensation value in a predetermined target compensation lookup table; and inputting a data voltage into a data line in the display panel according to the target gray scale value of each sub-pixel in the current row, to charge with a corresponding data voltage to each sub-pixel in the current row; where the target compensation value is obtained according to a set gray scale picture and a set overload picture displayed on the display panel.

In some embodiments, the display device further includes a memory; where
the memory is configured for storing the predetermined target compensation lookup table; and
the time controller is further configured for obtaining the target compensation lookup table from the memory when electrified.

In some embodiments, the display panel includes a plurality of source drive circuits, different source drive circuits being connected to different data lines; and
the time controller is further configured for:
dividing a display area into a plurality of initial partitions in a row direction of sub-pixels according to an area where the data line connected to the source drive circuit is positioned; where one source drive circuit corresponds to at least one initial partition; and
dividing each initial partition into a plurality of compensation areas in a column direction of sub-pixels.

### BRIEF DESCRIPTION OF THE DRAWINGS

FIG. 1A shows some schematic structural diagrams of a display device in an embodiment of the present disclosure.

FIG. 1B shows some other schematic structural diagrams of a display device in an embodiment of the present disclosure.

FIG. 2 shows some schematic structural diagrams of a display panel in an embodiment of the present disclosure.

FIG. 3 shows some signal time sequence diagrams in an embodiment of the present disclosure.

FIG. 4 shows some other signal time sequence diagrams in an embodiment of the present disclosure.

FIG. 5 shows some other schematic structural diagrams of a display panel in an embodiment of the present disclosure.

FIG. 6 shows some yet other signal time sequence diagrams in an embodiment of the present disclosure.

FIG. 7 shows some yet other signal time sequence diagrams in an embodiment of the present disclosure.

FIG. 8 shows some flowcharts of a driving method in an embodiment of the present disclosure.

FIG. 9 is a schematic diagram of some target compensation lookup tables in an embodiment of the present disclosure.

FIG. 10 is a schematic diagram of some original compensation lookup tables in an embodiment of the present disclosure.

FIG. 11 shows some schematic diagrams of compensation areas in an embodiment of the present disclosure.

FIG. 12 shows some other schematic diagrams of compensation areas in an embodiment of the present disclosure.

FIG. 13 shows some yet other schematic diagrams of compensation areas in an embodiment of the present disclosure.

FIG. 14 shows some yet other schematic diagrams of compensation areas in an embodiment of the present disclosure.

FIG. 15 shows some yet other schematic diagrams of compensation areas in an embodiment of the present disclosure.

FIG. 16 shows some yet other schematic diagrams of compensation areas in an embodiment of the present disclosure.

FIG. 17 shows some yet other schematic diagrams of compensation areas in an embodiment of the present disclosure.

### DETAILED DESCRIPTION OF THE EMBODIMENTS

In order to make the objectives, technical solutions, and advantages in embodiments of the present disclosure clearer, the technical solutions in embodiments of the present disclosure will be clearly and completely described below with reference to the accompanying drawings in embodiments of the present disclosure. It is obvious that the described embodiments are some rather than all of embodiments of the present disclosure. Moreover, embodiments of the present disclosure and features in embodiments can be combined with one another without conflict. Based on the described embodiments of the present disclosure, all other embodiments obtained by those of ordinary skill in the art without creative efforts fall within the scope of protection of the present disclosure.

Unless otherwise defined, technical or scientific terms used in the present disclosure should have ordinary meaning as understood by those of ordinary skill in the art to which the present disclosure belongs. “First”, “second”, etc. used in the present disclosure do not mean any order, quantity or importance, but are only used for distinguishing between different components. “Comprise”, “encompass”, etc. are intended to mean that an element or item in front of the word encompasses elements or items that are listed behind the word and equivalents thereof, but do not exclude other elements or items. “Connect”, “connected”, etc. are not limited to a physical or mechanical connection, but can include an electrical connection, whether direct or indirect.

It should be noted that sizes and shapes of all figures in the accompanying drawings do not reflect true scales, and are merely intended to illustrate contents of the present disclosure. Moreover, the same or similar reference numerals denote the same or similar elements or elements having the same or similar function throughout.

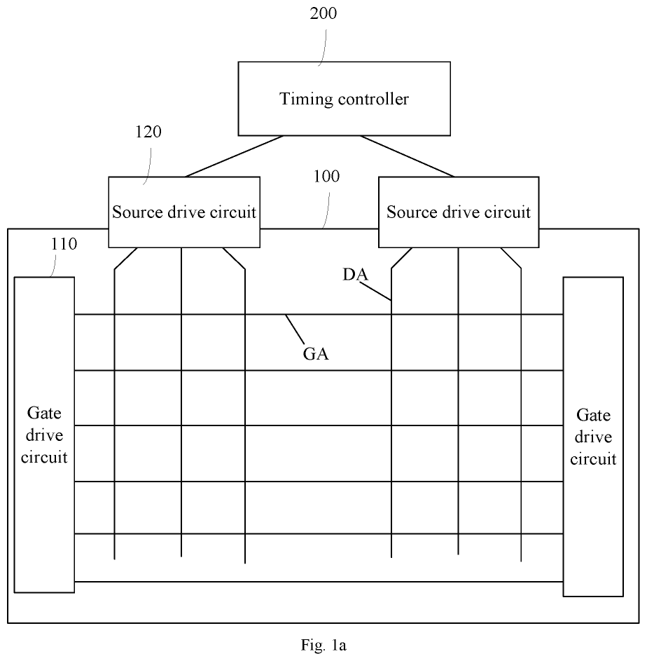

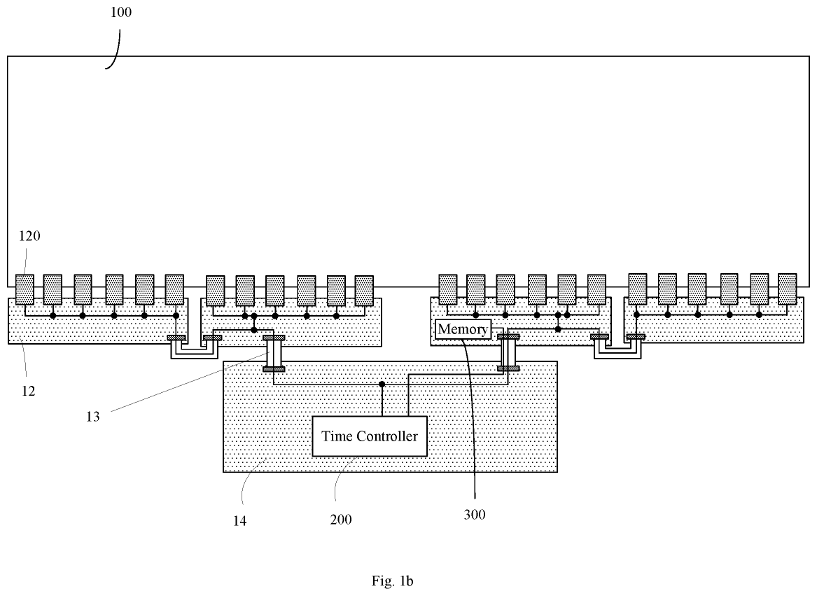

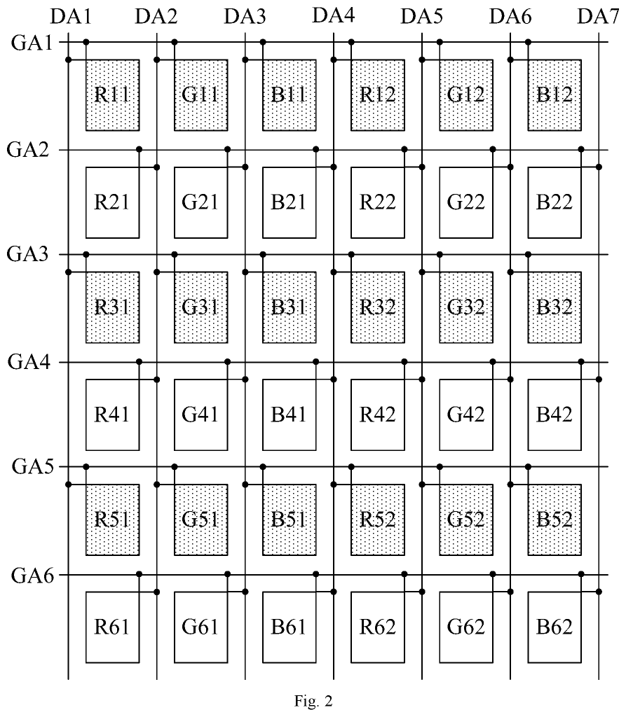

As shown in FIGS. 1A, 1B, and 2, a display device may include a display panel 100 and a time controller 200. The display panel 100 may include a plurality of pixel units arranged in an array, a plurality of gate lines GAs (In some embodiments, GA1, GA2, GA3, GA4, GA5, and GA6), a plurality of data lines DAs (In some embodiments, DA1, DA2, DA3, DA4, DA5, DA6, and DA7), a gate drive circuit 110, and a source drive circuit 120. The gate drive circuit 110 is coupled to the gate lines GAs (In some embodiments, GA1, GA2, GA3, GA4, GA5, and GA6), and the source drive circuit 120 is coupled to the data lines DAs (In some embodiments, DA1, DA2, DA3, DA4, DA5, DA6, and DA7). Herein, the time controller 200 may input a control signal to the gate drive circuit 110, so that the gate drive circuit 110 inputs a signal to the gate lines GAs (In some embodiments, GA1, GA2, GA3, GA4, GA5, and GA6) to drive the gate lines GAs (In some embodiments, GA1, GA2, GA3, GA4, GA5, and GA6). The time controller 200 inputs display data to the source drive circuit 120, so that the source drive circuit 120 may input a data voltage to the data line according to the display data, thereby charging the sub-pixel, and a corresponding data voltage is input into the sub-pixel, thereby realizing a picture display function. In some embodiments, a plurality of source drive circuits 120 may be provided, and different source drive circuits are connected to different data lines. In some embodiments, two source drive circuits 120 may be provided, where one source drive circuit 120 is connected to half of the data lines, and the other source drive circuit 120 is connected to the other half of the data lines. Certainly, three, four, or more source drive circuits 120 may be provided, which may be designed and determined according to requirements of actual applications, and is not limited herein.

In some embodiments, the time controller may obtain gray scale values of all sub-pixels in a current row and gray scale values of all sub-pixels in a previous row; determining a target gray scale value corresponding to each sub-pixel in the current row according to the gray scale value of each sub-pixel in the current row, the gray scale value of each sub-pixel in the previous row, and a target compensation value in a predetermined target compensation lookup table; inputting a data voltage into a data line in the display panel according to the target gray scale value of each sub-pixel in the current row, so that each sub-pixel in the current row is charged with a corresponding data voltage.

In some embodiments, each pixel unit includes a plurality of sub-pixels. In some embodiments, the pixel unit may include a red sub-pixel, a green sub-pixel, and a blue sub-pixel, so that color mixing may be performed through red, green, and blue colors to realize color display. Alternatively, the pixel unit may further include a red sub-pixel, a green sub-pixel, a blue sub-pixel, and a white sub-pixel, so that color mixing may be performed through red, green, blue, and white colors to realize color display. Certainly, in actual applications, a color emitted by the sub-pixel in the pixel unit may be designed and determined according to an actual application environment, which is not limited herein.

In some embodiments, each sub-pixel includes a transistor pixel electrode. One row of sub-pixels is correspondingly coupled to one gate line. With one column of sub-pixels as an embodiment, sub-pixels in odd rows in the column of sub-pixels are coupled to a data line on the left of the column of sub-pixels, and sub-pixels in even rows are coupled to a data line on the right of the column of sub-pixels. Alternatively, sub-pixels in odd rows in the column of sub-pixels are coupled to a data line on the right of the column of sub-pixels, and sub-pixels in even rows are coupled to a data line on the left of the column of sub-pixels. Also, a gate of a transistor is electrically connected to a corresponding gate line, a source of the transistor is electrically connected to a corresponding data line, and a drain of the transistor is electrically connected to a pixel electrode. It should be noted that a pixel array structure of the present disclosure may also be a double-gate structure, that is, two gate lines are arranged between two adjacent rows of pixels. Such an arrangement mode may reduce half of the data lines, that is, data lines are arranged between some of two adjacent columns of pixels, and no data lines are included between some of two adjacent columns of pixels. A specific pixel arrangement structure and an arrangement mode of the data lines and scanning lines are not limited.

It is to be noted that the display panel in embodiments of the present disclosure may be a liquid crystal display panel, an organic light-emitting diode (OLED) display panel, etc., which is not limited herein.

A gray scale is generally used to divide a brightness change area between a darkest area and a brightest area into several parts for facilitating screen brightness control. In some embodiments, a displayed image is composed of three colors, red, green, and blue colors, each of which may exhibit different brightness levels, and red, green, and blue colors having different brightness levels may be combined to form different colors. In some embodiments, if the liquid crystal display panel has a gray scale bit of 6 bits, the red, green, and blue colors have each 64 (that is, 2⁶) gray scales, the 64 gray scale values being 0-63, respectively. If the liquid crystal display panel has a gray scale bit of 8 bits, the red, green, and blue colors have each 256 (that is, 2⁸) gray scales, the 256 gray scale values being 0-255, respectively. If the liquid crystal display panel has a gray scale bit of 10 bits, the red, green, and blue colors have each 1024 (that is, 2¹⁰) gray scales, the 1024 gray scale values being 0-1023, respectively. If the liquid crystal display panel has a gray scale bit of 12 bits, the red, green, and blue colors have each 4096 (that is, 2¹²) gray scales, the 4096 gray scale values being 0-4093, respectively.

With one sub-pixel as an embodiment, when a data voltage input into a pixel electrode of the sub-pixel is greater than a common electrode voltage, liquid crystal molecules at the sub-pixel may have a positive polarity, and a polarity corresponding to the data voltage in the sub-pixel is positive. When a data voltage input into the pixel electrode of the sub-pixel is lower than the common electrode voltage, the liquid crystal molecules at the sub-pixel may have a negative polarity, and a polarity corresponding to the data voltage in the sub-pixel is negative. In some embodiments, the common electrode voltage may be 8.3 V. If a data voltage of 8.3 V-16V is input into the pixel electrode of the sub-pixel, the liquid crystal molecules at the sub-pixel may have a positive polarity, and the data voltage of 8.3 V-16 V is a data voltage corresponding to the positive polarity. If a data voltage of 0.6 V-8.3V is input into the pixel electrode of the sub-pixel, the liquid crystal molecules at the sub-pixel may have a negative polarity, and the data voltage of 0.6 V-8.3V is a data voltage corresponding to the negative polarity. In some embodiments, with the gray scales 0-255 of 8 bits as an embodiment, if a data voltage of 16 V is input into the pixel electrode of the sub-pixel, the sub-pixel may correspond to brightness of a maximum gray scale value of the positive polarity. When a data voltage of 0.6 V is input into the pixel electrode of the sub-pixel, the sub-pixel may correspond to brightness of a maximum gray scale value of the negative polarity. In this way, the display panel may realize a frame inversion mode, a column inversion mode, a row inversion mode, a dot inversion mode, etc. by controlling the polarity corresponding to the sub-pixel.

When the display panel displays a picture, some factors may lead to uneven display (that is, Mura). Generally, the Mura type defects may be divided into two types, one of which is charging rate Mura caused by a non-uniform charging rate of the sub-pixel, and the other of which is conventional Mura caused by factors in a manufacturing process of the display panel, such as a preparation process. Generally, the conventional Mura may occur when the display panel displays all pictures, while the charging rate Mura may occur under some special pictures (caused by the non-uniform charging rate). In some embodiments, the charging rate Mura may occur when an overload picture (In some embodiments, the overload picture may be a picture displayed when a gray scale value difference between two adjacent rows is large; and with 8 bits as an embodiment, the overload picture may be a picture displayed when a gray scale value difference between two adjacent rows is over 127) is displayed.

A pixel unit including a red sub-pixel, a green sub-pixel, and a blue sub-pixel is described as an embodiment below. As shown in FIG. 2, a red sub-pixel R11, a green sub-pixel G11, and a blue sub-pixel B11 form a pixel unit, and a red sub-pixel R12, a green sub-pixel G12, and a blue sub-pixel B12 form a pixel unit. A red sub-pixel R21, a green sub-pixel G21, and a blue sub-pixel B21 form a pixel unit, and a red sub-pixel R22, a green sub-pixel G22, and a blue sub-pixel B22 form a pixel unit. A red sub-pixel R31, a green sub-pixel G31, and a blue sub-pixel B31 form a pixel unit, and a red sub-pixel R32, a green sub-pixel G32, and a blue sub-pixel B32 form a pixel unit. A red sub-pixel R41, a green sub-pixel G41, and a blue sub-pixel B41 form a pixel unit, and a red sub-pixel R42, a green sub-pixel G42, and a blue sub-pixel B42 form a pixel unit. A red sub-pixel R51, a green sub-pixel G51, and a blue sub-pixel B51 form a pixel unit, and a red sub-pixel R52, a green sub-pixel G52, and a blue sub-pixel B52 form a pixel unit. A red sub-pixel R61, a green sub-pixel G61, and a blue sub-pixel B61 form a pixel unit, and a red sub-pixel R62, a green sub-pixel G62, and a blue sub-pixel B62 form a pixel unit.

In some embodiments, as shown in FIG. 2, the green sub-pixel G11, the red sub-pixel R21, the green sub-pixel G31, the red sub-pixel R41, the green sub-pixel G51, and the red sub-pixel R61 are coupled to the data line DA2. The blue sub-pixel B11, the green sub-pixel G21, the blue sub-pixel B31, the green sub-pixel G41, the blue sub-pixel B51, and the green sub-pixel G61 are coupled to the data line DA3. The red sub-pixel R12, the blue sub-pixel B21, the red sub-pixel R32, the blue sub-pixel B41, the red sub-pixel R52, and the blue sub-pixel B61 are coupled to the data line DA4. The green sub-pixel G12, the red sub-pixel R22, the green sub-pixel G32, the red sub-pixel R42, the green sub-pixel G52, and the red sub-pixel R62 are coupled to the data line DA5. The blue sub-pixel B12, the green sub-pixel G22, the blue sub-pixel B32, the green sub-pixel G42, the blue sub-pixel B52, and the green sub-pixel G62 are coupled to the data line DA6.

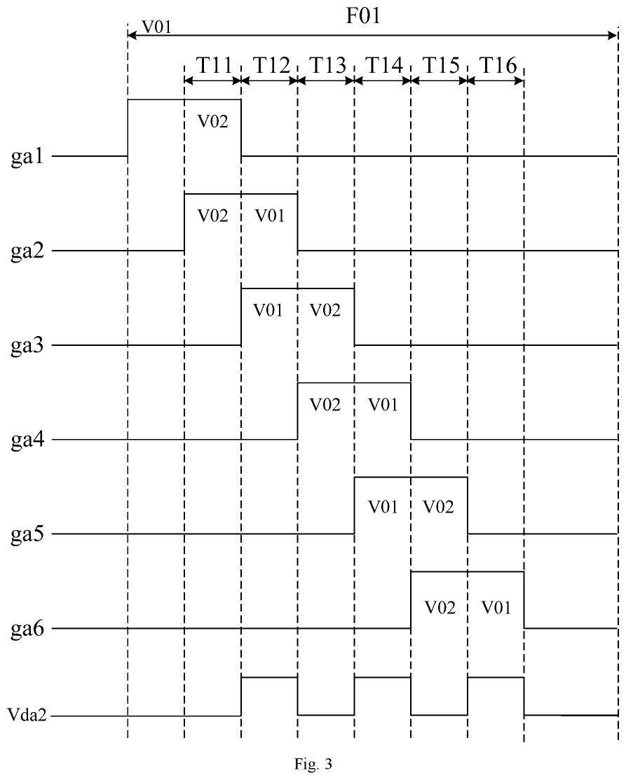

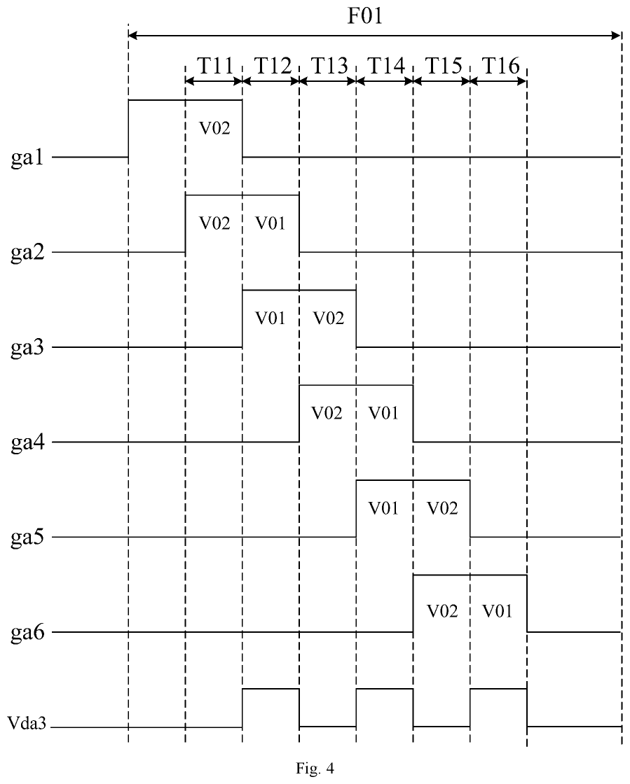

In some embodiments, with a first row of sub-pixels corresponding to the gray scale value 0, a second row of sub-pixels corresponding to the gray scale value 192, a third row of sub-pixels corresponding to the gray scale value 0, a fourth row of sub-pixels corresponding to the gray scale value 192, a fifth row of sub-pixels corresponding to the gray scale value 0, and a sixth row of sub-pixels corresponding to the gray scale value 192, so as to form an overload picture as an embodiment, a process of driving the display panel to display the overload picture may be described as follows, as shown in FIGS. 2-4. ga1 represents a signal loaded on the gate line GA1, ga2 represents a signal loaded on the gate line GA2, ga3 represents a signal loaded on the gate line GA3, ga4 represents a signal loaded on the gate line GA4, ga5 represents a signal loaded on the gate line GA5, and ga6 represents a signal loaded on the gate line GA6. Vda2 represents a data voltage loaded on the data line DA2, and Vda3 represents a data voltage loaded on the data line DA3. Also, the high level of the signals ga1-ga6 may be used as a gate turn-on signal to control a transistor in the sub-pixel to be turned on. With a display frame F01, the data lines DA2 and DA3, and a sub-pixel connected to the data lines DA2 and DA3 as an embodiment, when the signal ga1 on the gate line GA1 outputs a high-level gate turn-on signal, transistors in the green sub-pixel G11 and the blue sub-pixel B11 are turned on.

In a time period T11 corresponding to the high level of the signal ga1, a data voltage V02 corresponding to the gray scale value 0 is loaded on the data line DA2 connected to the green sub-pixel G11, so that the data voltage V02 is input into the green sub-pixel G11. Also, in the time period T11, the signal ga2 on the gate line GA2 outputs a high-level gate turn-on signal, and a transistor in the red sub-pixel R21 is turned on. The data voltage V02 is also input into the red sub-pixel R21 to precharge the red sub-pixel R21. Also, in the time period T11 corresponding to the high level of the signal ga1, the data voltage V02 corresponding to the gray scale value 0 is loaded on the data line DA3 connected to the blue sub-pixel B11, so that the data voltage V02 is input into the blue sub-pixel B11. Also, in the time period T11, the signal ga2 on the gate line GA2 outputs a high-level gate turn-on signal, and a transistor in the green sub-pixel G21 is turned on. The data voltage V02 is also input into the green sub-pixel G21 to precharge the green sub-pixel G21.

In a time period T12 corresponding to the high level of the signal ga2, a data voltage V01 corresponding to the gray scale value 192 is loaded on the data line DA2 connected to the red sub-pixel R21, so that the red sub-pixel R21 is charged with the data voltage V01. Also, in the time period T12, the signal ga3 on the gate line GA3 outputs a high-level gate turn-on signal, and a transistor in the green sub-pixel G31 is turned on. The data voltage V01 is also input into the green sub-pixel G31 to precharge the green sub-pixel G31. Also, in the time period T12 corresponding to the high level of the signal ga2, the data voltage V01 corresponding to the gray scale value 192 is loaded on the data line DA3 connected to the green sub-pixel G21, so that the data voltage V01 is input into the green sub-pixel G21. Also, in the time period T12, the signal ga3 on the gate line GA3 outputs a high-level gate turn-on signal, and a transistor in the blue sub-pixel B31 is turned on. The data voltage V01 is also input into the blue sub-pixel B31 to precharge the green sub-pixel B31.

In a time period T13 corresponding to the high level of the signal ga3, the data voltage V02 corresponding to the gray scale value 0 is loaded on the data line DA2 connected to the green sub-pixel G31, so that the green sub-pixel G31 is charged with the data voltage V02. Also, in the time period T13, the signal ga4 on the gate line GA4 outputs a high-level gate turn-on signal, and a transistor in the red sub-pixel R41 is turned on. The data voltage V02 is also input into the red sub-pixel R41 to precharge the red sub-pixel R41. Also, in the time period T13 corresponding to the high level of the signal ga3, the data voltage V02 corresponding to the gray scale value 0 is loaded on the data line DA3 connected to the blue sub-pixel B31, so that the blue sub-pixel B31 is charged with the data voltage V02. Also, in the time period T13, the signal ga4 on the gate line GA4 outputs a high-level gate turn-on signal, and a transistor in the green sub-pixel G41 is turned on. The data voltage V02 is also input into the green sub-pixel G41 to precharge the green sub-pixel G41.

In a time period T14 corresponding to the high level of the signal ga4, the data voltage V01 corresponding to the gray scale value 192 is loaded on the data line DA2 connected to the red sub-pixel R41, so that the red sub-pixel R41 is charged with the data voltage V01. Also, in the time period T14, the signal ga5 on the gate line GA5 outputs a high-level gate turn-on signal, and a transistor in the green sub-pixel G51 is turned on. The data voltage V01 is also input into the green sub-pixel G51 to precharge the green sub-pixel G51. Also, in the time period T14 corresponding to the high level of the signal ga4, the data voltage V01 corresponding to the gray scale value 192 is loaded on the data line DA3 connected to the green sub-pixel G41, so that the data voltage V01 is input into the green sub-pixel G41. Also, in the time period T14, the signal ga5 on the gate line GA5 outputs a high-level gate turn-on signal, and a transistor in the blue sub-pixel B51 is turned on. The data voltage V01 is also input into the blue sub-pixel B51 to precharge the green sub-pixel B51.

In a time period T15 corresponding to the high level of the signal ga5, the data voltage V02 corresponding to the gray scale value 0 is loaded on the data line DA2 connected to the green sub-pixel G51, so that the green sub-pixel G51 is charged with the data voltage V02. Also, in the time period T15, the signal ga6 on the gate line GA6 outputs a high-level gate turn-on signal, and a transistor in the red sub-pixel R61 is turned on. The data voltage V02 is also input into the red sub-pixel R51 to precharge the red sub-pixel R51. Also, in the time period T15 corresponding to the high level of the signal ga5, the data voltage V02 corresponding to the gray scale value 0 is loaded on the data line DA3 connected to the blue sub-pixel B51, so that the blue sub-pixel B51 is charged with the data voltage V02. Also, in the time period T15, the signal ga6 on the gate line GA6 outputs a high-level gate turn-on signal, and a transistor in the green sub-pixel G61 is turned on. The data voltage V02 is also input into the green sub-pixel G61 to precharge the green sub-pixel G61.

In a time period T16 corresponding to the high level of the signal ga6, the data voltage V01 corresponding to the gray scale value 192 is loaded on the data line DA2 connected to the red sub-pixel R61, so that the red sub-pixel R61 is charged with the data voltage V01, and a next sub-pixel is precharged. Also, in the time period T16 corresponding to the high level of the signal ga6, the data voltage V01 corresponding to the gray scale value 192 is loaded on the data line DA3 connected to the green sub-pixel G61, so that the data voltage V01 is input into the green sub-pixel G61, and a next sub-pixel is precharged, and so on until the sub-pixels in an entire display panel are charged with the data voltages, which will not be described in detail herein.

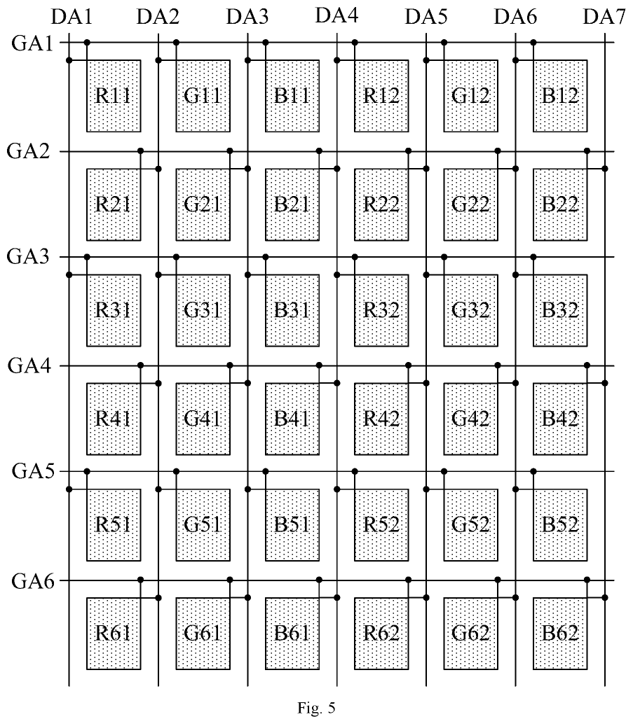

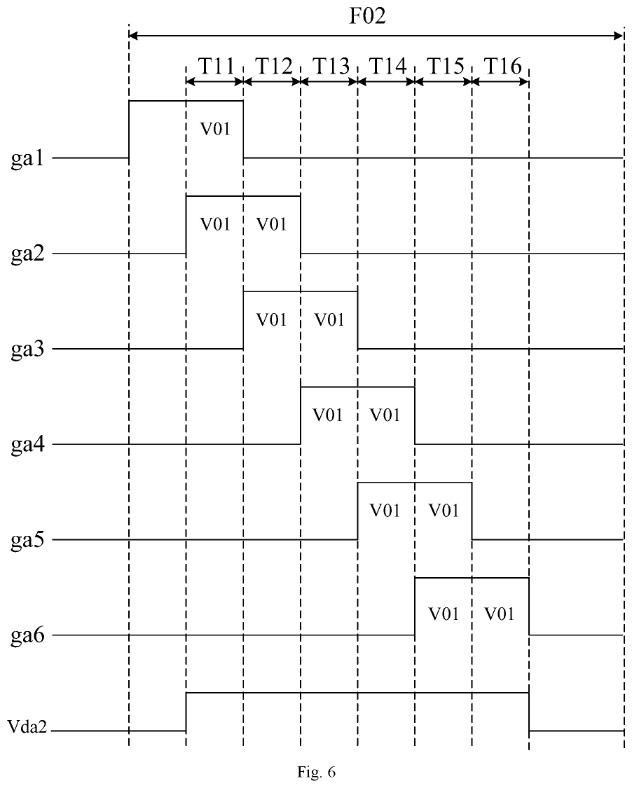

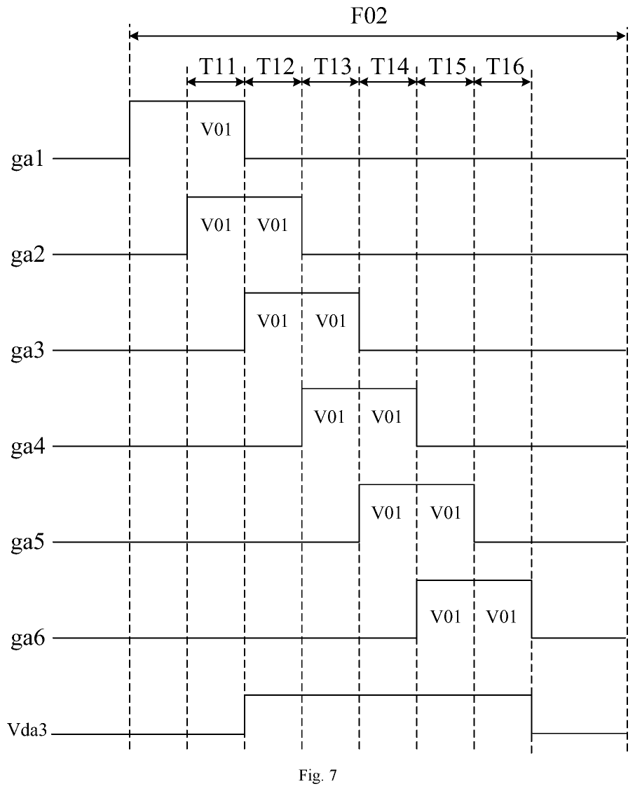

In some embodiments, with a gray scale picture formed by lighting up the red sub-pixel, the green sub-pixel, and the blue sub-pixel as an embodiment, the data voltage corresponding to the gray scale value 192 may be controlled to be input into the red sub-pixel, the green sub-pixel, and the blue sub-pixel in the display panel separately, so as to display the gray scale picture described above. As shown in FIGS. 5-7, a process of driving a display panel to display the overload picture may be described as follows. ga1 represents a signal loaded on the gate line GA1, ga2 represents a signal loaded on the gate line GA2, ga3 represents a signal loaded on the gate line GA3, ga4 represents a signal loaded on the gate line GA4, ga5 represents a signal loaded on the gate line GA5, and ga6 represents a signal loaded on the gate line GA6. Vda2 represents a data voltage loaded on the data line DA2, and Vda3 represents a data voltage loaded on the data line DA3. Also, the high level of the signals ga1-ga6 may be used as a gate turn-on signal to control a transistor in the sub-pixel to be turned on. With a display frame F02, the data lines DA2 and DA3, and a sub-pixel connected to the data lines DA2 and DA3 as an embodiment, when the signal ga1 on the gate line GA1 outputs a high-level gate turn-on signal, transistors in the green sub-pixel G11 and the blue sub-pixel B11 are turned on. Also, in a time period T11 corresponding to the high level of the signal ga1, a data voltage V01 corresponding to the gray scale value 192 is loaded on the data line DA2 connected to the green sub-pixel G11, so that the data voltage V01 is input into the green sub-pixel G11. Also, in the time period T11, the signal ga2 on the gate line GA2 outputs a high-level gate turn-on signal, and a transistor in the red sub-pixel R21 is turned on. The data voltage V01 is also input into the red sub-pixel R21 to precharge the red sub-pixel R21. Also, in the time period T11 corresponding to the high level of the signal ga1, the data voltage V01 corresponding to the gray scale value 192 is loaded on the data line DA3 connected to the blue sub-pixel B11, so that the data voltage V01 is input into the blue sub-pixel B11. Also, in the time period T11, the signal ga2 on the gate line GA2 outputs a high-level gate turn-on signal, and a transistor in the green sub-pixel G21 is turned on. The data voltage V01 is also input into the green sub-pixel G21 to precharge the green sub-pixel G21.

In a time period T12 corresponding to the high level of the signal ga2, the data voltage V01 corresponding to the gray scale value 192 is loaded on the data line DA2 connected to the red sub-pixel R21, so that the red sub-pixel R21 is charged with the data voltage V01. Also, in the time period T12, the signal ga3 on the gate line GA3 outputs a high-level gate turn-on signal, and a transistor in the green sub-pixel G31 is turned on. The data voltage V01 is also input into the green sub-pixel G31 to precharge the green sub-pixel G31. Also, in the time period T12 corresponding to the high level of the signal ga2, the data voltage V01 corresponding to the gray scale value 192 is loaded on the data line DA3 connected to the green sub-pixel G21, so that the data voltage V01 is input into the green sub-pixel G21. Also, in the time period T12, the signal ga3 on the gate line GA3 outputs a high-level gate turn-on signal, and a transistor in the blue sub-pixel B31 is turned on. The data voltage V01 is also input into the blue sub-pixel B31 to precharge the green sub-pixel B31.

In a time period T13 corresponding to the high level of the signal ga3, the data voltage V01 corresponding to the gray scale value 192 is loaded on the data line DA2 connected to the green sub-pixel G31, so that the green sub-pixel G31 is charged with the data voltage V01. Also, in the time period T13, the signal ga4 on the gate line GA4 outputs a high-level gate turn-on signal, and a transistor in the red sub-pixel R41 is turned on. The data voltage V01 is also input into the red sub-pixel R41 to precharge the red sub-pixel R41. Also, in the time period T13 corresponding to the high level of the signal ga3, the data voltage V01 corresponding to the gray scale value 192 is loaded on the data line DA3 connected to the blue sub-pixel B31, so that the blue sub-pixel B31 is charged with the data voltage V01. Also, in the time period T13, the signal ga4 on the gate line GA4 outputs a high-level gate turn-on signal, and a transistor in the green sub-pixel G41 is turned on. The data voltage V01 is also input into the green sub-pixel G41 to precharge the green sub-pixel G41.

In a time period T14 corresponding to the high level of the signal ga4, the data voltage V01 corresponding to the gray scale value 192 is loaded on the data line DA2 connected to the red sub-pixel R41, so that the red sub-pixel R41 is charged with the data voltage V01. Also, in the time period T14, the signal ga5 on the gate line GA5 outputs a high-level gate turn-on signal, and a transistor in the green sub-pixel G51 is turned on. The data voltage V01 is also input into the green sub-pixel G51 to precharge the green sub-pixel G51. Also, in the time period T14 corresponding to the high level of the signal ga4, the data voltage V01 corresponding to the gray scale value 192 is loaded on the data line DA3 connected to the green sub-pixel G41, so that the data voltage V01 is input into the green sub-pixel G41. Also, in the time period T14, the signal ga5 on the gate line GA5 outputs a high-level gate turn-on signal, and a transistor in the blue sub-pixel B51 is turned on. The data voltage V01 is also input into the blue sub-pixel B51 to precharge the green sub-pixel B51.

In a time period T15 corresponding to the high level of the signal ga5, the data voltage V01 corresponding to the gray scale value 192 is loaded on the data line DA2 connected to the green sub-pixel G51, so that the green sub-pixel G51 is charged with the data voltage V01. Also, in the time period T15, the signal ga6 on the gate line GA6 outputs a high-level gate turn-on signal, and a transistor in the red sub-pixel R61 is turned on. The data voltage V01 is also input into the red sub-pixel R51 to precharge the red sub-pixel R51. Also, in the time period T15 corresponding to the high level of the signal ga5, the data voltage V01 corresponding to the gray scale value 192 is loaded on the data line DA3 connected to the blue sub-pixel B51, so that the blue sub-pixel B51 is charged with the data voltage V01. Also, in the time period T15, the signal ga6 on the gate line GA6 outputs a high-level gate turn-on signal, and a transistor in the green sub-pixel G61 is turned on. The data voltage V01 is also input into the green sub-pixel G61 to precharge the green sub-pixel G61.

In a time period T16 corresponding to the high level of the signal ga6, the data voltage V01 corresponding to the gray scale value 192 is loaded on the data line DA2 connected to the red sub-pixel R61, so that the red sub-pixel R61 is charged with the data voltage V01, and a next sub-pixel is precharged. Also, in the time period T16 corresponding to the high level of the signal ga6, the data voltage V01 corresponding to the gray scale value 192 is loaded on the data line DA3 connected to the green sub-pixel G61, so that the data voltage V01 is input into the green sub-pixel G61, and a next sub-pixel is precharged, and so on until the sub-pixels in an entire display panel are charged with the data voltages, which will not be described in detail herein.

As can be seen from the above description, for the overload picture described above, with the green sub-pixel G21 and the green sub-pixel G31 as an embodiment, the green sub-pixel G31 is changed from the precharged voltage V02 to the data voltage V01, and the green sub-pixel G21 is changed from the precharged voltage V01 to the data voltage V02, resulting in a charging difference between the green sub-pixel G21 and the green sub-pixel G31. Similarly, a charging difference also exists between the red sub-pixels connected to the data line DA4, and so on, which will not be described in detail herein. The charging difference between the sub-pixels may result in fine lines on the picture of the display panel, leading to the poor display of the display panel, that is, the charging rate Mura caused by the non-uniform charging rate.

In order to alleviate the charging rate Mura, an over drive (OD) technique may be employed to compensate different sub-pixels. In some embodiments, in the same column, when a gray scale value of a sub-pixel in a previous row is 0 and a gray scale value of a sub-pixel in a next row is 192, the gray scale value of the sub-pixel in the next row may be changed from 192 to 210 through the OD technique, that is, the green sub-pixel G21 is changed from the precharged voltage V02 to the data voltage V03 corresponding to the gray scale value 210, so as to improve the charging rate of the display panel. In view of the above, an OD compensation table may be obtained. Moreover, in consideration of a charging rate difference between different areas of the display panel, the panel may be divided into a plurality of partitions, different partitions having different compensation gains (that is, gain values), so that a partition gain value table may be obtained. In this way, the display panel may be controlled to display the picture according to the obtained OD compensation table and partition gain value table (that is, through a De-Mura method).

However, the charging rate Mura is generally more serious under the overload picture. While the charging rate Mura in the overload picture may be alleviated through the De-Mura method described above, other pictures (such as the gray scale picture described above) almost have no the charging rate Mura, that is, a picture quality of other pictures is less affected by the charging rate Mura, and is more affected by the conventional Mura. The De-Mura method described above may cause overcompensation under the gray scale picture, and thus fail to effectively alleviate the charging rate Mura.

In order to alleviate the problem described above, an embodiment of the present disclosure provides a method for driving a display panel. The method includes a target compensation lookup table formed by target compensation values obtained according to a set gray scale picture and a set overload picture displayed on the display panel is predetermined, so that after gray scale values of all sub-pixels in a current row and gray scale values of all sub-pixels in a previous row are obtained, a target gray scale value corresponding to each sub-pixel in the current row may be determined according to the gray scale value of each sub-pixel in the current row, the gray scale value of each sub-pixel in the previous row, and the target compensation value in the predetermined target compensation lookup table, so that the target gray scale value is related to both the conventional Mura when the display panel displays the set gray scale picture and the charging rate Mura when the display panel displays the set overload picture. In this way, when a data voltage is input to a data line in the display panel according to the target gray scale value of each sub-pixel in the current row, so that each sub-pixel in the current row is charged with a corresponding data voltage to display a picture, a picture quality is less affected by both the conventional Mura and the charging rate Mura.

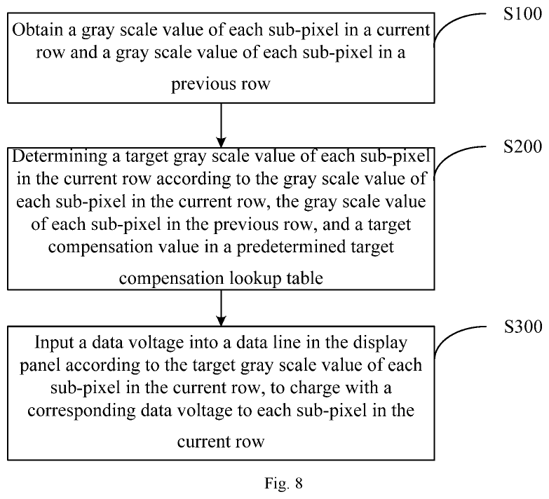

As shown in FIG. 8, an embodiment of the present disclosure provides some methods for driving display panels. The method may include following steps.

S100, a gray scale value of each sub-pixel in a current row and a gray scale value of each sub-pixel in a previous row are obtained.

In some embodiments, the obtained gray scale value of each sub-pixel in the current row may be an original gray scale value of each sub-pixel in the current row. In some embodiments, original display data of each sub-pixel in the current row may be obtained, the original display data including a digital voltage form of data voltages carrying corresponding gray scale values and corresponding one-to-one to all the sub-pixels in the current row. Also, the gray scale value corresponding to the data voltage is the original gray scale value. In this way, the original gray scale value of each sub-pixel in the current row may be determined according to the original display data of each sub-pixel in the current row.

In some embodiments, the obtained gray scale value of each sub-pixel in the previous row may be an original gray scale value of each sub-pixel in the previous row. In some embodiments, original display data of each sub-pixel in the previous row may be obtained, the original display data including a digital voltage form of data voltages carrying corresponding gray scale values and corresponding one-to-one to all the sub-pixels in the previous row. Also, the gray scale value corresponding to the data voltage is the original gray scale value. In this way, the original gray scale value of each sub-pixel in the previous row may be determined according to the original display data of each sub-pixel in the previous row.

S200, a target gray scale value of each sub-pixel in the current row is determined according to the gray scale value of each sub-pixel in the current row, the gray scale value of each sub-pixel in the previous row, and a target compensation value in a predetermined target compensation lookup table.

In some embodiments of the present disclosure, the target compensation value is obtained according to a set gray scale picture and a set overload picture displayed on the display panel. In some embodiments, the set gray scale picture may be a picture displayed when a red sub-pixel, a green sub-pixel, and a blue sub-pixel in the display panel are all charged with a data voltage of the same gray scale value. In some embodiments, the set gray scale picture may be a picture displayed when the red sub-pixel, the green sub-pixel, and the blue sub-pixel in the display panel are all charged with a data voltage of a gray scale value 192. Alternatively, the set gray scale picture may be a picture displayed when the red sub-pixel, the green sub-pixel, and the blue sub-pixel in the display panel are all charged with a data voltage of a gray scale value 127. In some embodiments, the set overload picture may be a picture displayed when a gray scale value difference between a gray scale value corresponding to a data voltage for precharging of the sub-pixel in the display panel and a gray scale value corresponding to a data voltage for charging the sub-pixel is large (for example, with 8 bits as an embodiment, a gray scale difference is over 63). In some embodiments, the set overload picture may be a picture displayed when a gray scale value difference between two adjacent rows is large. In some embodiments, with 8 bits as an embodiment, the set overload picture may be a picture displayed when a gray scale value difference between two adjacent rows is over 127. In some embodiments, the set overload picture may be a picture displayed when a first row of sub-pixels correspond to a gray scale value 0, a second row of sub-pixels correspond to a gray scale value 192, a third row of sub-pixels correspond to a gray scale value 0, a fourth row of sub-pixels correspond to a gray scale value 192, a fifth row of sub-pixels correspond to a gray scale value 0, and a sixth row of sub-pixels correspond to a gray scale value 192 in the display panel. Certainly, in the embodiment of the present disclosure, the set gray scale picture and the set overload picture may also be determined according to requirements of actual applications, which is not limited herein.

In some embodiments, a display device may further include a memory. In this way, the predetermined target compensation lookup table may be stored in the memory. In some embodiments, FIG. 1B illustrates a connection relation between a time controller and a source drive circuit 120. As shown in FIG. 1B, 120 represents a source drive circuit, 12 represents a printed circuit board (PCB), 13 represents a flexible printed circuit (FPC), and 14 represents a time sequence circuit board where the time controller is positioned. 300 represents a memory. In some embodiments, the memory 300 may be arranged on one printed circuit board 12, and one time controller may be arranged on the time sequence circuit board, so as to reduce the difficulty in integration. Two time controllers (for example, one serves as a master time controller and the other serves as a slave time controller) may also be arranged on the time sequence circuit board, so as to improve a drive capacity and a computation capacity and to facilitate the application in a display panel with a high refresh rate (for example, 120 Hz, 240 Hz, etc.). In some embodiments, the time controller 200 may acquire the target compensation lookup table from the memory 300 when electrified. In some embodiments, when the time controller 200 is electrified, a memory of the time controller 200 may acquire the target compensation lookup table from the memory 300 and store the target compensation lookup table. When the time controller controls the display panel to display a picture, the stored target compensation lookup table may be directly called from the memory of the time controller 200.

In some embodiments, the target compensation lookup table may include: a plurality of first different gray scale values, a plurality of second different gray scale values, and target compensation values corresponding to any one of the first gray scale values and any one of the second gray scale values. In some embodiments, the target compensation lookup table has a corresponding gray scale bit, that is, a first gray scale value, a second gray scale value, and a target lookup gray scale value in the target compensation lookup table have a corresponding gray scale bit. In some embodiments, if the gray scale bit corresponding to the target compensation lookup table is 8 bits, the gray scale bit corresponding to the first gray scale value, the second gray scale value, and the target lookup gray scale value may be 8 bits. In some embodiments, in the target compensation lookup table, the first gray scale value may be any one of the gray scale values 0-255 in 8 bits, and the second gray scale value may be any one of the gray scale values 0-255 in 8 bits. Alternatively, in the target compensation lookup table, the first gray scale value may be any one of some of the gray scale values 0-255 in 8 bits, and the second gray scale value may be any one of some of the gray scale values 0-255 in 8 bits.

FIG. 9 illustrates some target compensation lookup tables in the embodiment of the present disclosure. As show in FIG. 9, the target compensation lookup table includes some of the first gray scale values and some of the second gray scale values in 8 bits and target compensation values corresponding to these first gray scale values and second gray scale values. Values in a first row in FIG. 9 (for example, 0, 16, 32, 48, 64, 80, 96, 112, 128, 144, 160, 176, 192, 208, 224, 240, and 255) denote the first gray scale values, values in a first column (for example, 0, 16, 32, 48, 64, 80, 96, 112, 128, 144, 160, 176, 192, 208, 224, 240, and 255) denote the second gray scale values, and remaining values (for example, L1-1-L17-17) denote the target compensation values. It should be noted that the specific gray scale values illustrated in FIG. 9 are only exemplary. In actual application, the specific gray scale values may be determined according to requirements of the actual application, which is not limited herein. It should be noted that the first gray scale value may correspond to the gray scale value of each sub-pixel in the previous row, and the second gray scale value may correspond to the gray scale value of each sub-pixel in the current row.

In some embodiments of the present disclosure, step S200 that a target gray scale value corresponding to each sub-pixel in the current row is determined according to the gray scale value of each sub-pixel in the current row, the gray scale value of each sub-pixel in the previous row, and a target compensation value in a predetermined target compensation lookup table may include: target compensation values corresponding to a gray scale value of a sub-pixel in the current row and a gray scale value of a sub-pixel in the previous row connected to the same data line may be determined from the target compensation lookup table. A value obtained by adding an original gray scale value of the sub-pixel in the current row connected to the same data line with the target compensation value is determined as the target gray scale value of the sub-pixel in the current row connected to the same data line. In some embodiments, as shown in FIG. 9, with the blue sub-pixel B11 connected to the data line DA3 as the sub-pixel in the previous row and the green sub-pixel G21 connected to the data line DA3 as the sub-pixel in the current row as an embodiment, if the blue sub-pixel B11 corresponds to the gray scale value 0 and the green sub-pixel G21 corresponds to the gray scale value 192, the corresponding target compensation value may be determined as L13-1 from the target compensation lookup table shown in FIG. 9. In this way, a value obtained by adding the gray scale value 192 corresponding to the green sub-pixel G21 with the target compensation value L13-1 may be used as the target gray scale value of the green sub-pixel G21.

S300, a data voltage is input into the data line in the display panel according to the target gray scale value of each sub-pixel in the current row, so that each sub-pixel in the current row is charged with a corresponding data voltage.

In some embodiments, with the green sub-pixel G21 as an embodiment, a data voltage of a corresponding target gray scale value may be input into the data line according to the determined target gray scale value corresponding to the green sub-pixel G21, so that the green sub-pixel G21 is charged with the data voltage of the corresponding target gray scale value, and so on, which will not be described in detail herein.

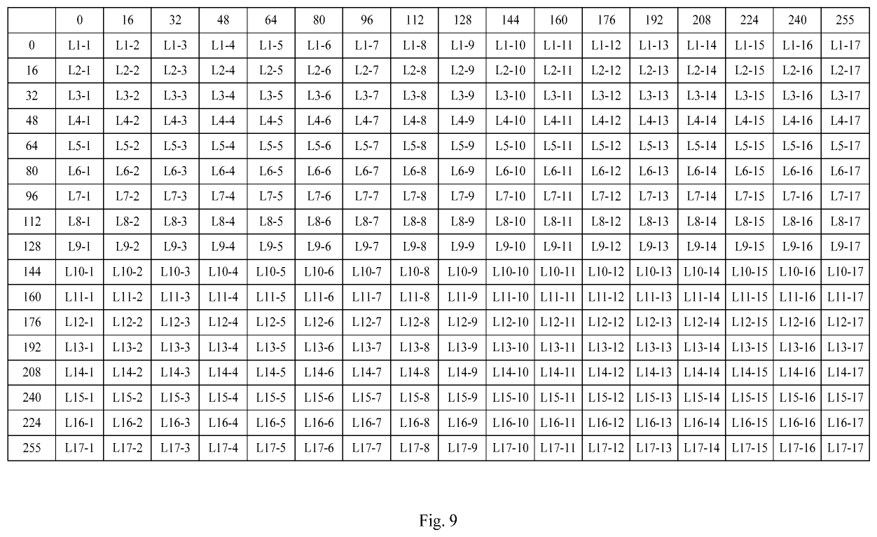

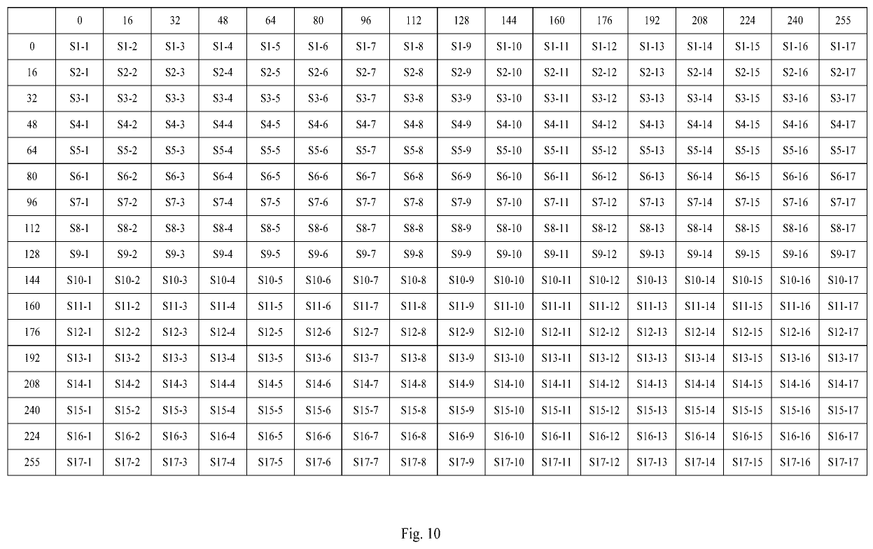

In some embodiments of the present disclosure, the step that a target compensation value in the determined target compensation lookup table is determined may include: an original compensation lookup table is obtained, where the original compensation lookup table includes: a plurality of first different gray scale values, a plurality of second different gray scale values, and original compensation values corresponding to any one of the first gray scale values and any one of the second gray scale values. In some embodiments, the first gray scale value in the original compensation lookup table is the same as the first gray scale value in the target compensation lookup table, and the second gray scale value in the original compensation lookup table is the same as the second gray scale value in the target compensation lookup table. In some embodiments, FIG. 10 illustrates some original compensation lookup tables in the embodiment of the present disclosure. As shown in FIG. 10, the original compensation lookup table includes some of the first gray scale values and some of the second gray scale values in 8 bits, and original compensation values corresponding to these first gray scale values and second gray scale values. Values in a first row in FIG. 10 (for example, 0, 16, 32, 48, 64, 80, 96, 112, 128, 144, 160, 176, 192, 208, 224, 240, and 255) denote the first gray scale values, values in a first column (for example, 0, 16, 32, 48, 64, 80, 96, 112, 128, 144, 160, 176, 192, 208, 224, 240, and 255) denote the second gray scale values, and remaining values (for example, S1-1-S17-17) denote the original compensation values. It should be noted that specific gray scale values illustrated in FIG. 10 are only exemplary. In actual application, the specific gray scale values may be determined according to requirements of the actual application, which is not limited herein.

Then the target compensation value in the target compensation lookup table may be determined according to a predetermined compensation gain and the original compensation value in the original compensation lookup table. In some embodiments, as shown in FIGS. 9 and 10, an original compensation value S2-1 in the original compensation lookup table may be combined with the predetermined compensation gain to obtain a target compensation value L2-1 in the target compensation lookup table. An original compensation value S4-5 in the original compensation lookup table may be combined with the predetermined compensation gain to obtain a target compensation value L4-5 in the target compensation lookup table, and so on, which will not be described in detail herein. Since the compensation gain is obtained according to the set gray scale picture and the set overload picture displayed on the display panel, the target gray scale value may be related to both the conventional Mura when the display panel displays the set gray scale picture and the charging rate Mura when the display panel displays the set overload picture.

A dual-Gate or Tri-Gate design is employed on a large-size high-resolution display panel to reduce a cost by reducing the number of source drive circuits. Generally, the data lines are connected to the source drive circuit through a fan-out line of a fan-out area. Since a fan-out line corresponding to the middle of the source drive circuit and fan-out lines corresponding to two ends of the source drive circuit have different lengths, the fan-out lines connected to the source drive circuit have different resistance, and a sub-pixel corresponding to the middle of the source drive circuit and sub-pixels corresponding to the two ends of the source drive circuit also have different charging rates, which is expressed as the charging rate Mura. In order to alleviate the problem described above, a compensation resistor may be added in the source drive circuit. In consideration of material share, display panels of different size generally use source drive circuits of the same specification. However, owing to a size difference, a side frame width difference, a fan-out line length difference, a fan-out line thickness difference, etc. of the display panels of different sizes, the same version of compensation resistor will not optimally match the display panel of each size, resulting in poor compensation effect of the charging rate Mura of the display panels of different sizes. In some embodiments of the present disclosure, a compensation area may be divided according to the source drive circuit. In some embodiments, the time controller may divide a display area into a plurality of initial partitions in a row direction of the sub-pixels according to an area where the data line connected to the source drive circuit is positioned. One source drive circuit corresponds to at least one initial partition. Then each initial partition is divided into a plurality of compensation areas in a column direction of the sub-pixels. In some embodiments, the number of initial partitions corresponding to each source drive circuit is the same. In some embodiments, one source drive circuit may correspond to one initial partition, or one source drive circuit may correspond to two initial partitions, or one source drive circuit may correspond to three initial partitions. Certainly, in actual application, the number of the initial partitions corresponding to one source drive circuit may be determined according to requirements of the actual application, which is not limited herein.

In some embodiments, as shown in FIGS. 1A and 11, when the display panel has two source drive circuits, each source drive circuit corresponds to two initial partitions. One source drive circuit corresponds to initial partitions CS1 and CS2, and the other source drive circuit corresponds to initial partitions CS3 and CS4. Also, the initial partition CS1 is divided into compensation areas QB-1, QB-5, QB-9, and QB-13 in a column direction of sub-pixels. The initial partition CS2 is divided into compensation areas QB-2, QB-6, QB-10, and QB-14 in a column direction of sub-pixels. The initial partition CS3 is divided into compensation areas QB-3, QB-7, QB-11, and QB-15 in a column direction of sub-pixels. The initial partition CS4 is divided into compensation areas QB-4, QB-8, QB-12, and QB-16 in a column direction of sub-pixels.

In some embodiments, considering that different areas of the display panel have different charging rates, the display area of the display panel may be directly divided into a plurality of compensation areas equally.

Certainly, in the embodiments of the present disclosure, the mode of dividing the compensation area may also be determined according to requirements of actual application, which is not limited herein.

In some embodiments of the present disclosure, one compensation area may correspond to one target compensation lookup table, one compensation gain, and one original compensation lookup table. For each compensation area, the step that a target compensation value in the target compensation lookup table is determined may include: an original compensation lookup table corresponding to the compensation area is obtained, and the target compensation value in the target compensation lookup table corresponding to the compensation area is determined according to a predetermined compensation gain and an original compensation value in the original compensation lookup table corresponding to the compensation area. In some embodiments, as shown in FIG. 11, the display area of the display panel may be divided into 4*4 compensation areas QB-1-QB-16 equally. The compensation area QB-1 corresponds to one target compensation lookup table, one compensation gain, and one original compensation lookup table, so that the target compensation value in the target compensation lookup table corresponding to compensation area QB-1 may be determined according to the original compensation value in the original compensation lookup table and the compensation gain corresponding to the compensation area QB-1. Also, the compensation area QB-2 corresponds to one target compensation lookup table, one compensation gain, and one original compensation lookup table, so that the target compensation value in the target compensation lookup table corresponding to the compensation area QB-2 may be determined according to the original compensation value in the original compensation lookup table and the compensation gain corresponding to the compensation area QB-2, and so on, which will not be described in detail herein.

In some embodiments of the present disclosure, the step that a compensation gain corresponding to each compensation area is determined may include: the display panel is controlled to display a set overload picture, and an overload detection image when the display panel displays the set overload picture is collected. An overload detection compensation value corresponding to each compensation area is determined according to brightness of the overload detection image in each compensation area. Also, the display panel is controlled to display a set gray scale picture, and a gray scale detection image is collected when the display panel displays the set gray scale picture. A gray scale detection compensation value corresponding to each compensation area is determined according to brightness of the gray scale detection image in each compensation area. In this way, a compensation gain corresponding to each compensation area may be determined according to the gray scale detection compensation value and the overload detection compensation value corresponding to each compensation area. In some embodiments, a formula Gi1_a=1+(Dc1_a-Dn1_a)/Ds may be employed to determine the compensation gain corresponding to each compensation area according to the gray scale detection compensation value and the overload detection compensation value corresponding to each compensation area. Gi1_a represents a compensation gain corresponding to an ath compensation area, Dc1_a represents an overload detection compensation value corresponding to the ath compensation area, Dn1_a represents a gray scale detection compensation value corresponding to the ath compensation area, Ds represents a reference value, and a is an integer greater than 0.

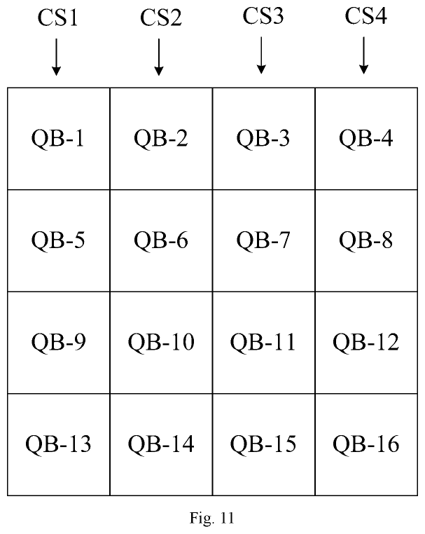

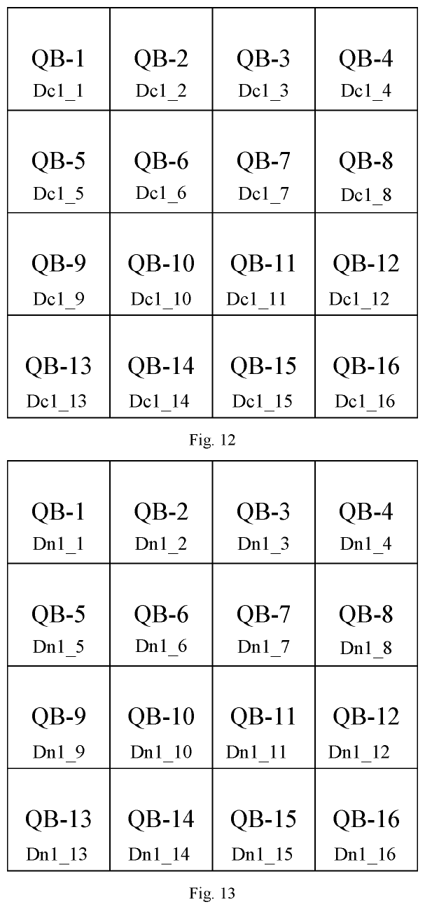

In some embodiments, as shown in FIGS. 11 and 12, Dc1_1 represents an overload detection compensation value corresponding to the first compensation area QB-1, Dc1_2 represents an overload detection compensation value corresponding to the second compensation area QB-2, Dc1_3 represents an overload detection compensation value corresponding to the third compensation area QB-3, . . . , and Dc1_16 represents an overload detection compensation value corresponding to the sixteenth compensation area QB-16. The overload detection compensation value Dc1_1 may be determined according to brightness of the overload detection image in the first compensation area QB-1. The overload detection compensation value Dc1_2 may be determined according to brightness of the overload detection image in the second compensation area QB-2. The overload detection compensation value Dc1_3 may be determined according to brightness of the overload detection image in the third compensation area QB-3 . . . . The overload detection compensation value Dc1_16 may be determined according to brightness of the overload detection image in the sixteenth compensation area QB-16.

In some embodiments, as shown in FIGS. 11 and 13, Dn1_1 represents a gray scale detection compensation value corresponding to the first compensation area QB-1, Dn1_2 represents a gray scale detection compensation value corresponding to the second compensation area QB-2, Dn1_3 represents a gray scale detection compensation value corresponding to the third compensation area QB-3, . . . , and Dn1_16 represents a gray scale detection compensation value corresponding to the sixteenth compensation area QB-16. The gray scale detection compensation value Dn1_1 may be determined according to brightness of the gray scale detection image in the first compensation area QB-1. The gray scale detection compensation value Dn1_2 may be determined according to brightness of the gray scale detection image in the second compensation area QB-2. The gray scale detection compensation value Dn1_3 may be determined according to brightness of the gray scale detection image in the third compensation area QB-3 . . . . The gray scale detection compensation value Dn1_16 may be determined according to brightness of the gray scale detection image in the sixteenth compensation area QB-16.

In some embodiments, as shown in FIGS. 11 and 14, Gill represents a compensation gain corresponding to the first compensation area QB-1, Gi1_2 represents a compensation gain corresponding to the second compensation area QB-2, Gi1_3 represents a compensation gain corresponding to the third compensation area QB-3, . . . , and Gi1_16 represents a compensation gain corresponding to the sixteenth compensation area QB-16. Gi1_1=1+(Dc1_1-Dn1_1)/Ds,

$$Gi 1 \_ 2 = 1 + ( Dc1\_ 2 - Dn 1 \_ 2 ) / Ds , Gi 1 \_ 3 = 1 + ( Dc1\_ 3 - Dn1\_ 3 ) / Ds , Gi 1 \_ 16 = 1 + ( Dc1\_ 16 - Dn1\_ 16 ) / Ds .$$

In some embodiments, the reference value may be obtained empirically, or one of the gray scale detection compensation values. In some embodiments, a gray scale detection compensation value corresponding to a portion, without the conventional Mura, of the compensation area in the gray scale detection image may be used as the reference value. In some embodiments, as shown in FIG. 13, if QB-3 does not have the conventional Mura, Dn1_3 may be used as the reference value.

In some embodiments of the present disclosure, a formula LMD1_a=LYD1_a*Gi1_a may be employed to determine the target compensation value in the target compensation lookup table corresponding to the compensation area. LMD1_a represents a target compensation value in a target compensation lookup table corresponding to an ath compensation area, and LYD1_a represents an original compensation value in an original compensation lookup table corresponding to the ath compensation area.

With the first compensation area QB-1 as an embodiment, FIG. 9 is used as the target compensation lookup table corresponding to the first compensation area QB-1, and FIG. 10 is used as the original compensation lookup table corresponding to the first compensation area QB-1. When LYD1_1 is S4-5, LMD1_1 is L4-5, that is, L4-5=S4-5*Gi1_1. When LYD1_1 is S2-1, LMD1_1 is L2-1, that is, L2-1=S2-1*Gi1_1, and so on, which will not be described in detail herein.

It should be noted that the number of the compensation areas may be determined according to requirements of actual applications, which is not limited herein.

Embodiments of the present disclosure further provide some other methods for driving display panels, which are varied with respect to the embodiment in the embodiment described above. Merely differences between the present embodiment and the embodiment described above will be described, and the similarities will not be described in detail herein.

In some embodiments of the present disclosure, a formula Gi2_a=Dc2_a-Dn2_a may be employed to determine the compensation gain corresponding to each compensation area according to the gray scale detection compensation value and the overload detection compensation value corresponding to each compensation area. Gi2_a represents a compensation gain corresponding to the ath compensation area, Dc2_a represents an overload detection compensation value corresponding to the ath compensation area, Dn2_a represents a gray scale detection compensation value corresponding to the ath compensation area, and a is an integer greater than 0.

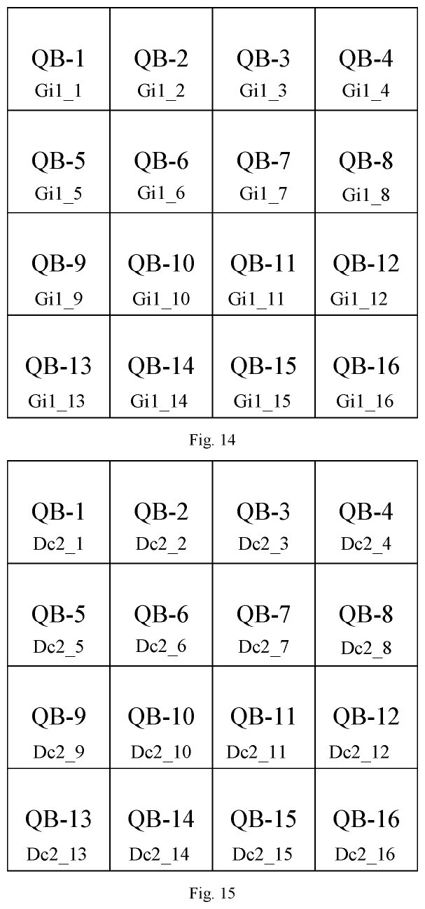

In some embodiments, as shown in FIGS. 11 and 15, Dc2_1 represents an overload detection compensation value corresponding to the first compensation area QB-1, Dc2_2 represents an overload detection compensation value corresponding to the second compensation area QB-2, Dc2_3 represents an overload detection compensation value corresponding to the third compensation area QB-3, . . . , and Dc2_16 represents an overload detection compensation value corresponding to the sixteenth compensation area QB-16. The overload detection compensation value Dc2_1 may be determined according to brightness of the overload detection image in the first compensation area QB-1. The overload detection compensation value Dc2_2 may be determined according to brightness of the overload detection image in the second compensation area QB-2. The overload detection compensation value Dc2_3 may be determined according to brightness of the overload detection image in the third compensation area QB-3 . . . . The overload detection compensation value Dc2_16 may be determined according to brightness of the overload detection image in the sixteenth compensation area QB-16.

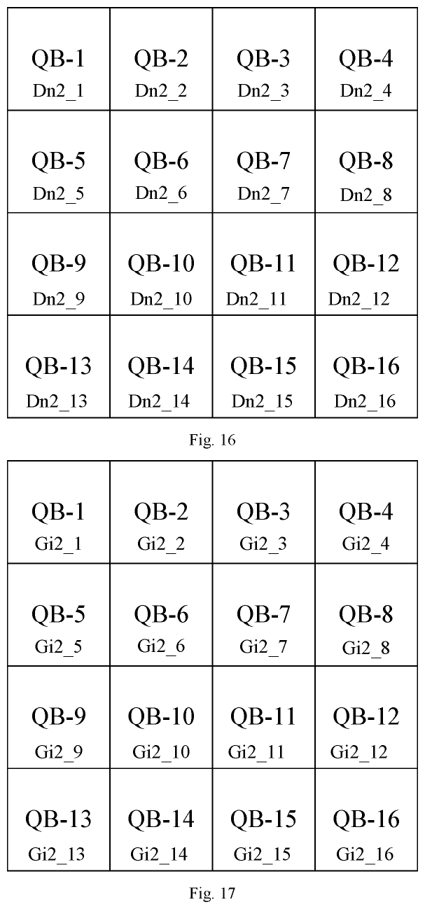

In some embodiments, as shown in FIGS. 11 and 16, Dn2_1 represents a gray scale detection compensation value corresponding to the first compensation area QB-1, Dn2_2 represents a gray scale detection compensation value corresponding to the second compensation area QB-2, Dn2_3 represents a gray scale detection compensation value corresponding to the third compensation area QB-3, . . . , and Dn2_16 represents a gray scale detection compensation value corresponding to the sixteenth compensation area QB-16. The gray scale detection compensation value Dn2_1 may be determined according to brightness of the gray scale detection image in the first compensation area QB-1. The gray scale detection compensation value Dn2_2 may be determined according to brightness of the gray scale detection image in the second compensation area QB-2. The gray scale detection compensation value Dn2_3 may be determined according to brightness of the gray scale detection image in the third compensation area QB-3 . . . . The gray scale detection compensation value Dn2_16 may be determined according to brightness of the gray scale detection image in the sixteenth compensation area QB-16.

In some embodiments, as shown in FIGS. 11 and 17, Gi2_1 represents a compensation gain corresponding to the first compensation area QB-1, Gi2_2 represents a compensation gain corresponding to the second compensation area QB-2, Gi2_3 represents a compensation gain corresponding to the third compensation area QB-3, . . . , and Gi2_16 represents a compensation gain corresponding to the sixteenth compensation area QB-16. Gi2_1=Dc2_1-Dn2_1, Gi2_2=Dc2_2-Dn2_2, Gi2_3=Dc2_3-Dn2_3, . . . , Gi2_16=Dc2_16-Dn2_16.

In some embodiments of the present disclosure, a formula LMD2_a=LYD2_a+Gi2_a may be employed to determine the target compensation value in the target compensation lookup table corresponding to the compensation area. LMD2_a represents a target compensation value in a target compensation lookup table corresponding to the ath compensation area, LYD2_a represents an original compensation value in an original compensation lookup table corresponding to the ath compensation area, and Gi2_a represents a compensation gain corresponding to the ath compensation area.

With the first compensation area QB-1 as an embodiment, FIG. 9 is used as the target compensation lookup table corresponding to the first compensation area QB-1, and FIG. 10 is used as the original compensation lookup table corresponding to the first compensation area QB-1. When LYD1_1 is S4-5, LMD1_1 is L4-5, that is, L4-5=S4-5+Gi1_1. When LYD1_1 is S2-1, LMD1_1 is L2-1, that is, L2-1=S2-1+Gi1_1, and so on, which will not be described in detail herein.

Embodiments of the present disclosure further provide some yet other methods for driving display panels, which are varied with respect to the embodiment in the embodiment described above. Merely differences between the present embodiment and the embodiment described above will be described, and the similarities will not be described in detail herein.

In some embodiments of the present disclosure, gray scale values of all sub-pixels in a current row are original gray scale values of all the sub-pixels in the current row, and gray scale values of all sub-pixels in a previous row are target gray scale values of all the sub-pixels in the previous row. In some embodiments, the obtained gray scale value of each sub-pixel in the current row may be the original gray scale value of each sub-pixel in the current row. In some embodiments, original display data of each sub-pixel in the current row may be obtained, the original display data including a digital voltage form of data voltages carrying corresponding gray scale values and corresponding one-to-one to all the sub-pixels in the current row. Also, the gray scale value corresponding to the data voltage is the original gray scale value. In this way, the original gray scale value of each sub-pixel in the current row may be determined according to the original display data of each sub-pixel in the current row.

In some embodiments, for one sub-pixel in the previous row, a target gray scale value corresponding to a data voltage charged into the sub-pixel is different from an original gray scale value corresponding to the sub-pixel. Also, the target gray scale value corresponding to the data voltage charged into each sub-pixel in the previous row is determined to be stored, so as to be obtained when a target gray scale value corresponding to a data voltage charged into each sub-pixel in the current row is determined. In this way, the obtained gray scale value of each sub-pixel in the previous row may be the target gray scale value of each sub-pixel in the previous row.

Those skilled in the art should understand that the embodiments of the present disclosure can be provided as methods, systems, or computer program products. Therefore, the present disclosure can employ full hardware embodiments, full software embodiments, or software and hardware combined embodiments. Moreover, the present disclosure can take the form of a computer program product that is implemented on one or more computer available storage media (including, but not limited to, a disk memory, a compact disk read-only memory (CD-ROM), an optical memory, etc.) that encompass computer available program codes.

The present disclosure is described with reference to flow charts and/or block diagrams of the methods, apparatuses (systems), and computer program products according to the embodiment of the present disclosure. It should be understood that each flow and/or block in the flow charts and/or block diagrams and combinations of the flows and/or blocks in the flow charts and/or block diagrams can be implemented through the computer program instructions. The computer program instructions may be provided for a processor of a general-purpose computer, a special-purpose computer, an embedded processor, or other programmable data processing apparatuses to produce a machine, so that instructions executed by the processor of the computer or other programmable data processing apparatuses produce a device used for implementing functions specified in one or more flows in each flowchart and/or one or more blocks in each block diagram.

These computer program instructions may also be stored in a computer-readable memory that is capable of guiding a computer or other programmable data processing apparatuses to work in a specific mode, so that the instructions stored in the computer-readable memory produce an article of manufacture including an instruction device, and the instruction device implements functions specified in one or more flows in each flowchart and/or one or more blocks in each block diagram.

These computer program instructions may also be loaded onto the computer or other programmable data processing apparatuses, so that a series of operations and steps are executed on the computer or other programmable apparatuses, thereby generating computer-implemented processing. Therefore, the instructions executed on the computer or other programmable apparatuses provide steps for implementing a specified function in one or more flows in each flow chart and/or in one or more blocks in each block diagram.

While the preferred embodiments of the present disclosure have been described, additional alterations and modifications to those embodiments can be made by those skilled in the art once the basic inventive concept is apparent to those skilled in the art. Therefore, it is intended that the appended claims are to be interpreted to include the preferred embodiments and all alterations and modifications that fall within the scope of the present disclosure.

It will be apparent to those skilled in the art that various modifications and variations can be made to the embodiments of the present disclosure without departing from the spirit and scope of the embodiments of the present disclosure. Thus, if these modifications and variations to the embodiments of the present disclosure fall within the scope of the claims of the present disclosure and their equivalents, it is intended that the present disclosure cover these modifications and variations as well.

1. A method for driving a display panel, comprising:
obtaining a gray scale value of each sub-pixel in a current row and a gray scale value of each sub-pixel in a previous row;
determining a target gray scale value of each sub-pixel in the current row according to the gray scale value of each sub-pixel in the current row, the gray scale value of each sub-pixel in the previous row, and a target compensation value in a predetermined target compensation lookup table; wherein the target compensation value is obtained according to a set gray scale picture and a set overload picture displayed on the display panel; and
inputting a data voltage into a data line in the display panel according to the target gray scale value of each sub-pixel in the current row, to charge with a corresponding data voltage to each sub-pixel in the current row.

2. The method for driving a display panel according to claim 1, wherein the target compensation lookup table comprises a plurality of different first gray scale values, a plurality of different second gray scale values, and target compensation values corresponding to any one of the first gray scale values, and target compensation values corresponding to any one of the second gray scale values; and
determining the target compensation value in the target compensation lookup table comprises:
obtaining an original compensation lookup table; wherein the original compensation lookup table comprises the plurality of different first gray scale values, the plurality of different second gray scale values, and original compensation values corresponding to any one of the first gray scale values, and original compensation values corresponding to any one of the second gray scale values; and
determining the target compensation value in the target compensation lookup table according to a predetermined compensation gain and the original compensation values in the original compensation lookup table; wherein the compensation gain is obtained according to the set gray scale picture and the set overload picture displayed on the display panel.

3. The method for driving a display panel according to claim 1, wherein a display area of the display panel has a plurality of predetermined compensation areas, one compensation area corresponding to one target compensation lookup table and one compensation gain; and
determining a target compensation value in the target compensation lookup table for each compensation area comprises:
obtaining an original compensation lookup table corresponding to the compensation area; and
determining the target compensation value in the target compensation lookup table corresponding to the compensation area according to a predetermined compensation gain corresponding to the compensation area and an original compensation value in the original compensation lookup table.

4. The method for driving a display panel according to claim 3, wherein determining the compensation gain corresponding to each compensation area comprises:
obtaining an overload detection image when the display panel displays the set overload picture, and a gray scale detection image when the display panel displays the set gray scale picture;
determining an overload detection compensation value corresponding to each compensation area according to brightness of the overload detection image in each compensation area, and determining a gray scale detection compensation value corresponding to each compensation area according to brightness of the gray scale detection image in each compensation area; and
determining the compensation gain corresponding to each compensation area according to the gray scale detection compensation value corresponding to each compensation area and the overload detection compensation value corresponding to each compensation area.

5. The method for driving a display panel according to claim 4, wherein the compensation gain corresponding to each compensation area is determined according to the gray scale detection compensation value corresponding to each compensation area and the overload detection compensation value corresponding to each compensation area through a formula as follows:
$$Gi 1 \_a = 1 + ( Dc 1 \_a - Dn1\_a ) / Ds ;$$
wherein Gi1_a represents the compensation gain corresponding to an ath compensation area, Dc1_a represents the overload detection compensation value corresponding to the ath compensation area, Dn1_a represents the gray scale detection compensation value corresponding to the ath compensation area, Ds represents a reference value, and a is an integer greater than 0.

6. The method for driving a display panel according to claim 5, wherein the reference value is one of the gray scale detection compensation values.

7. The method for driving a display panel according to claim 5, wherein the target compensation value in the target compensation lookup table corresponding to the compensation area is determined through a formula as follows:
$$LMD1\_a = LYD1\_a * Gi1\_a ;$$
wherein LMD1_a represents the target compensation value in the target compensation lookup table corresponding to the ath compensation area, and LYD1_a represents the original compensation value in the original compensation lookup table corresponding to the ath compensation area.

8. The method for driving a display panel according to claim 4, wherein the compensation gain corresponding to each compensation area is determined according to the gray scale detection compensation value corresponding to each compensation area and the overload detection compensation value corresponding to each compensation area through a formula as follows:
$$Gi2\_a = Dc2\_a - Dn2\_a ;$$
wherein Gi2_a represents the compensation gain corresponding to an ath compensation area, Dc2_a represents the overload detection compensation value corresponding to the ath compensation area, Dn2_a represents the gray scale detection compensation value corresponding to the ath compensation area, and a is an integer greater than 0.

9. The method for driving a display panel according to claim 8, wherein the target compensation value in the target compensation lookup table corresponding to the compensation area is determined through a formula as follows:
$$LMD2\_a = LYD2\_a + Gi2\_a ;$$
wherein LMD2_a represents the target compensation value in the target compensation lookup table corresponding to the ath compensation area, LYD2_a represents the original compensation value in the original compensation lookup table corresponding to the ath compensation area, and Gi2_a represents the compensation gain corresponding to the ath compensation area.

10. The method for driving a display panel according to claim 1, wherein the determining a target gray scale value corresponding to each sub-pixel in the current row according to the gray scale value of each sub-pixel in the current row, the gray scale value of each sub-pixel in the previous row, and a target compensation value in the predetermined target compensation lookup table comprises:
determining a target compensation value corresponding to a gray scale value of a sub-pixel in the current row and a gray scale value of a sub-pixel in the previous row both connected to the same data line from the target compensation lookup table; and
determining a target gray scale value of the sub-pixel in the current row connected to the same data line by adding an original gray scale value of the sub-pixel in the current row connected to the same data line with the target compensation value.

11. The method for driving a display panel according to claim 10, wherein the gray scale value of each sub-pixel in the current row is an original gray scale value of each sub-pixel in the current row; and
the gray scale value of each sub-pixel in the previous row is an original gray scale value of each sub-pixel in the previous row.

12. The method for driving a display panel according to claim 10, wherein the gray scale value of each sub-pixel in the current row is an original gray scale value of each sub-pixel in the current row; and
the gray scale value of each sub-pixel in the previous row is a target gray scale value of each sub-pixel in the previous row.

13. A display device, comprising:
a display panel; and
a time controller configured for obtaining a gray scale value of each sub-pixel in a current row and a gray scale value of each sub-pixel in a previous row; determining a target gray scale value of each sub-pixel in the current row according to the gray scale value of each sub-pixel in the current row, the gray scale value of each sub-pixel in the previous row, and a target compensation value in a predetermined target compensation lookup table; and inputting a data voltage into a data line in the display panel according to the target gray scale value of each sub-pixel in the current row, to charge with a corresponding data voltage to each sub-pixel in the current row; wherein the target compensation value is obtained according to a set gray scale picture and a set overload picture displayed on the display panel.

14. The display device according to claim 13, further comprising a memory; wherein
the memory is configured for storing the predetermined target compensation lookup table; and
the time controller is further configured for obtaining the target compensation lookup table from the memory when electrified.

15. The display device according to claim 14, wherein the display panel comprises a plurality of source drive circuits, different source drive circuits being connected to different data lines; and
the time controller is further configured for:
dividing a display area into a plurality of initial partitions in a row direction of sub-pixels according to an area where the data line connected to the source drive circuit is positioned; wherein one source drive circuit corresponds to at least one initial partition; and
dividing each initial partition into a plurality of compensation areas in a column direction of sub-pixels.

16. The method for driving a display panel according to claim 6, wherein the target compensation value in the target compensation lookup table corresponding to the compensation area is determined through a formula as follows:
$$LMD1\_a = LYD1\_a * Gi1\_a ;$$
wherein LMD1_a represents the target compensation value in the target compensation lookup table corresponding to the ath compensation area, and LYD1_a represents the original compensation value in the original compensation lookup table corresponding to the ath compensation area.

17. The display device according to claim 13, wherein the target compensation lookup table comprises a plurality of different first gray scale values, a plurality of different second gray scale values, and target compensation values corresponding to any one of the first gray scale values, and target compensation values corresponding to any one of the second gray scale values; and
the time controller is further configured for:
obtaining an original compensation lookup table; wherein the original compensation lookup table comprises the plurality of different first gray scale values, the plurality of different second gray scale values, and original compensation values corresponding to any one of the first gray scale values, and original compensation values corresponding to any one of the second gray scale values; and
determining the target compensation value in the target compensation lookup table according to a predetermined compensation gain and the original compensation values in the original compensation lookup table; wherein the compensation gain is obtained according to the set gray scale picture and the set overload picture displayed on the display panel.

18. The display device according to claim 13, wherein a display area of the display panel has a plurality of predetermined compensation areas, one compensation area corresponding to one target compensation lookup table and one compensation gain; and
the time controller is further configured for:
obtaining an original compensation lookup table corresponding to the compensation area; and
determining the target compensation value in the target compensation lookup table corresponding to the compensation area according to a predetermined compensation gain corresponding to the compensation area and an original compensation value in the original compensation lookup table.

19. The display device according to claim 17, wherein the time controller is further configured for:
obtaining an overload detection image when the display panel displays the set overload picture, and a gray scale detection image when the display panel displays the set gray scale picture;
determining an overload detection compensation value corresponding to each compensation area according to brightness of the overload detection image in each compensation area, and determining a gray scale detection compensation value corresponding to each compensation area according to brightness of the gray scale detection image in each compensation area; and
determining the compensation gain corresponding to each compensation area according to the gray scale detection compensation value corresponding to each compensation area and the overload detection compensation value corresponding to each compensation area.

20. The display device according to claim 13, wherein the time controller is further configured for:
determining a target compensation value corresponding to a gray scale value of a sub-pixel in the current row and a gray scale value of a sub-pixel in the previous row both connected to the same data line from the target compensation lookup table; and
determining a target gray scale value of the sub-pixel in the current row connected to the same data line by adding an original gray scale value of the sub-pixel in the current row connected to the same data line with the target compensation value.
